(19) United States
(12) Patent Application Publication
(10) Pub. No.: US 2012/0270502 A1
(43) Pub. Date: Oct. 25, 2012

(54) INFORMATION PROCESSOR, DISPLAY DEVICE, AND DEVICE CONTROL METHOD

(75) Inventor: Hiroshi Kazawa, Kumagaya-shi (JP)

(73) Assignee: KABUSHIKI KAISHA TOSHIBA, Tokyo (JP)

(21) Appl. No.: 13/325,997

(22) Filed: Dec. 14, 2011

(30) Foreign Application Priority Data
Apr. 22, 2011 (JP) 2011-096458

(51) Int. Cl. H04B 7/00

(52) U.S. Cl. 455/41.2

(57) ABSTRACT

According to one embodiment, an information processor includes a first location acquisition module, a second location acquisition module, an identifying module, and a transmitter. The first location acquisition module acquires own location information representing the location of the information processor. The second location acquisition module acquires display device location information representing the location of each of display devices capable of displaying data. The identifying module identifies one of the display devices to display the data based on the distance between the information processor and each of the display devices from the display device location information and the own location information. The transmitter transmits a request to display the data to the display device identified by the identifying module.

### CROSS-REFERENCE TO RELATED APPLICATIONS

This application is based upon and claims the benefit of priority from Japanese Patent Application No. 2011-096458, filed Apr. 22, 2011, the entire contents of which are incorporated herein by reference.

### FIELD

Embodiments described herein relate generally to an information processor, a display device, and a device control method.

### BACKGROUND

Nowadays, there have been used electronic devices conforming to the universal plug and play (UPnP, registered trademark) audio video (AV) standard and the digital living network alliance (DLNA) guideline. The UPnP AV standard is a protocol that allows, as an upper layer of the UPnP protocol, electronic devices to join a network by only connecting them to each other to reproduce audio-video (AV) content and the like. The DLNA guideline is an industry standard that allows electronic devices to have compatibility with each other to realize a home network among the electronic devices. The DLNA guideline adopts the UPnP protocol as a procedure of communications among the electronic devices.

The UPnP standard defines a device and a control point controlling the device. Meanwhile, the UPnP AV standard defines a media server (UPnP AV media server) storing therein content, and a media renderer (UPnP AV media renderer) reproducing content as the devices. The control point (UPnP AV control point) finds a device in the network and controls the device. In the UPnP AV standard, the media renderer selected by the control point acquires, through the network, content in the media server selected by the control point, and reproduces the content.

In a home network comprising a plurality of media servers and media renderers, operating a control terminal such as the control point allows desired content to be selected from the media servers and the desired content to be reproduced by a desired media renderer.

In the conventional technology, it is difficult to identify a media renderer that the user wants to use as a device to reproduce content (reproduction destination). Accordingly, a media renderer desired by the user is selected by using infrared communication. This requires the user's operation for the infrared communication to select the media renderer, which causes a large burden of the operation on the user.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic diagram of a structure of a network system in which a plurality of electronic devices are connected to each other according to a first embodiment;

FIG. 2 is an exemplary functional block diagram of a control point in the first embodiment;

FIG. 3 is an exemplary schematic diagram of a software structure of the control point in the first embodiment;

FIG. 4 is an exemplary block diagram of a hardware structure of a television device in the first embodiment;

FIG. 5 is an exemplary schematic diagram of a software structure of the television device in the first embodiment;

FIG. 6 is an exemplary schematic diagram illustrating a first example of screen transition of the control point in the first embodiment;

FIG. 7 is an exemplary schematic diagram illustrating a second example of screen transition of the control point in the first embodiment;

FIG. 8 is an exemplary sequence diagram illustrating a procedure of processing to reproduce content in the network system in the first embodiment;

FIG. 9 is an exemplary schematic diagram of a software structure of a control point according to a second embodiment;

FIG. 10 is an exemplary flowchart of processing performed by the control point to register the location of a media renderer in the second embodiment;

FIG. 11 is an exemplary sequence diagram illustrating a procedure of processing to reproduce content in a network system in the second embodiment;

FIG. 12 is an exemplary functional block diagram of a control point according to a third embodiment;

FIG. 13 is an exemplary schematic diagram of a software structure of the control point in the third embodiment;

FIG. 14 is an exemplary sequence diagram illustrating a procedure of processing to reproduce content in a network system in the third embodiment;

FIG. 15 is an exemplary schematic diagram of a structure of a network system according to a fourth embodiment; and

FIG. 16 is an exemplary flowchart of processing performed by the control point to switch the media renderers in the fourth embodiment.

### DETAILED DESCRIPTION

In general, according to one embodiment, an information processor, an information processor comprises a first location acquisition module, a second location acquisition module, an identifying module, and a transmitter. The first location acquisition module is configured to acquire own location information representing the location of the information processor. The second location acquisition module is configured to acquire display device location information representing the location of each of display devices capable of displaying data. The identifying module is configured to identify one of the display devices to display the data based on the distance between the information processor and each of the display devices from the display device location information and the own location information. The transmitter is configured to transmit a request to display the data to the display device identified by the identifying module.

Exemplary embodiments will be described in detail below with reference to the accompanying drawings. The information processor will be described by way of example as being applied to a control point and the display device to a television device. While, in the following embodiments, devices conforming to the universal plug and play (UPnP, registered trademark) audio visual (AV) standard and the digital living network alliance (DLNA) guideline are used, applicable devices are not limited to them. For example, the characteristic structures of the embodiments described below may be applied to devices or systems conforming to standards that are equivalent to or compatible with the above standard and the guideline, and also applied to devices or systems conforming to other standards and guidelines.

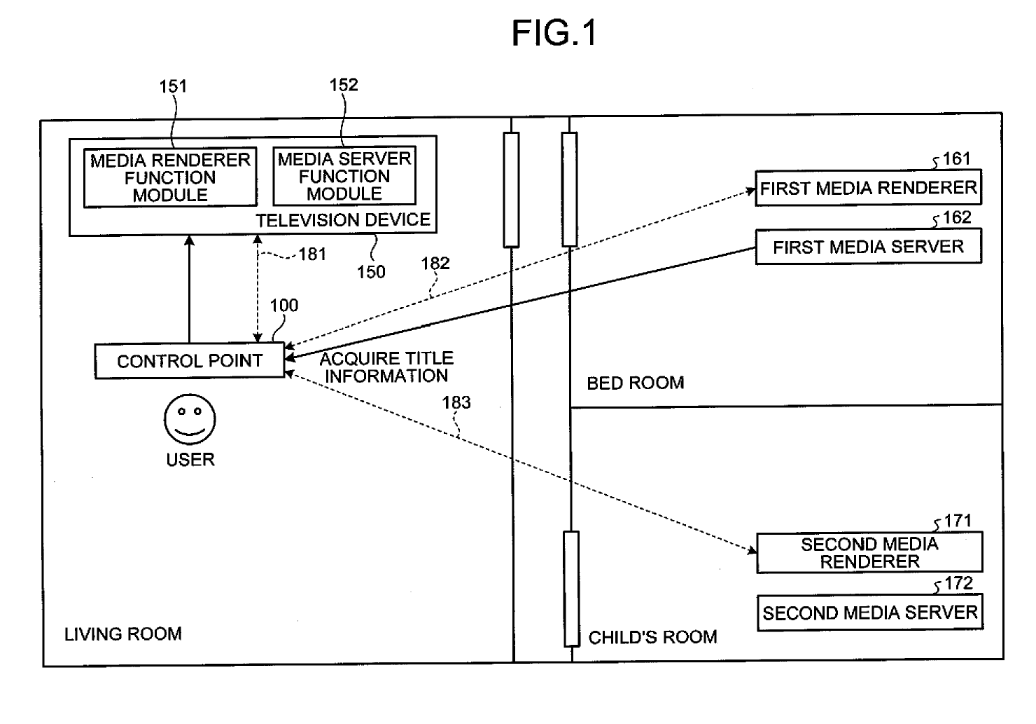

FIG. 1 schematically illustrates a structure of a network system according to a first embodiment. In the network system, a plurality of electronic devices are connected to each other. The electronic devices connected to each other in the network system illustrated in FIG. 1 are compliant with the UPnP AV standard and the DLNA guideline.

In the network system illustrated in FIG. 1, a control point 100 such as a smartphone, a television device 150, a first media renderer 161, a first media server 162, a second media renderer 171, and a second media server 172 are connected to each other as UPnP standard-compliant devices through a network such as a local area network (LAN). The network may be a wired network, a wireless network, or a mixed network of the wired and wireless networks. The number and types of devices connected to the network are not limited to those in the example of FIG. 1. Any UPnP AV-compliant device can be connected to the network.

A function that controls the following devices to reproduce content is called as a control point (UPnP AV control point) function. In the first embodiment, the control point 100 has the control point function.

In the first embodiment, a function that stores content, provides title information of the content to other electronic devices, and supplies designated content according to a request from a media renderer is called as a media server (UPnP AV media server) function. The home network system according to the embodiment comprises the devices having the media server function. Specifically, in the embodiment, the home network system comprises the television device 150, the first media server 162, and the second media server 172 as the devices having the media server function.

A function that receives a reproduction instruction from an electronic device having the control point function and content provided by the device having the media server function, and reproduces the content is called as a media renderer (UPnP AV media renderer) function. The home network system according to the embodiment comprises the devices having the media renderer function. Specifically, in the embodiment, the home network system comprises the television device 150, the first media renderer 161, and the second media renderer 171 as the devices having the media renderer function.

The television device 150 comprises a media server function module 152, and a media renderer function module 151.

In relation to the functions, the following system is called as a three-BOX reproduction system. Three types of electronic devices, i.e., the control point 100, a device having the media server function, and a device having the media renderer function are connected to each other over a network. One of the electronic devices, the control point 100 acquires a list of titles of content (also referred to as a title list of content) stored in the device having the media server function (hereinafter referred to as a media server), and instructs the device having the media renderer function (hereinafter referred to as a media renderer) to reproduce the content of the title designated from the title list.

The control point 100 of the first embodiment may be a portable device, such as a smartphone, that a user can carry anywhere. The control point 100 selects content stored in the media server, and displays the content on the desired media renderer.

The control point 100 of the first embodiment specifies and selects a media renderer to reproduce content based on the distance between the control point 100 and the media renderer. The media renderer to reproduce content is also referred to as a reproduction destination.

In the example illustrated in FIG. 1, the control point 100 calculates a distance 181 between the control point 100 and the television device 150, a distance 182 between the control point 100 and the first media renderer 161, and a distance 183 between the control point 100 and the second media renderer 171, and identifies the television device 150 that is located at the shortest distance from the control point 100 as the reproduction destination. The structure of each device will be described.

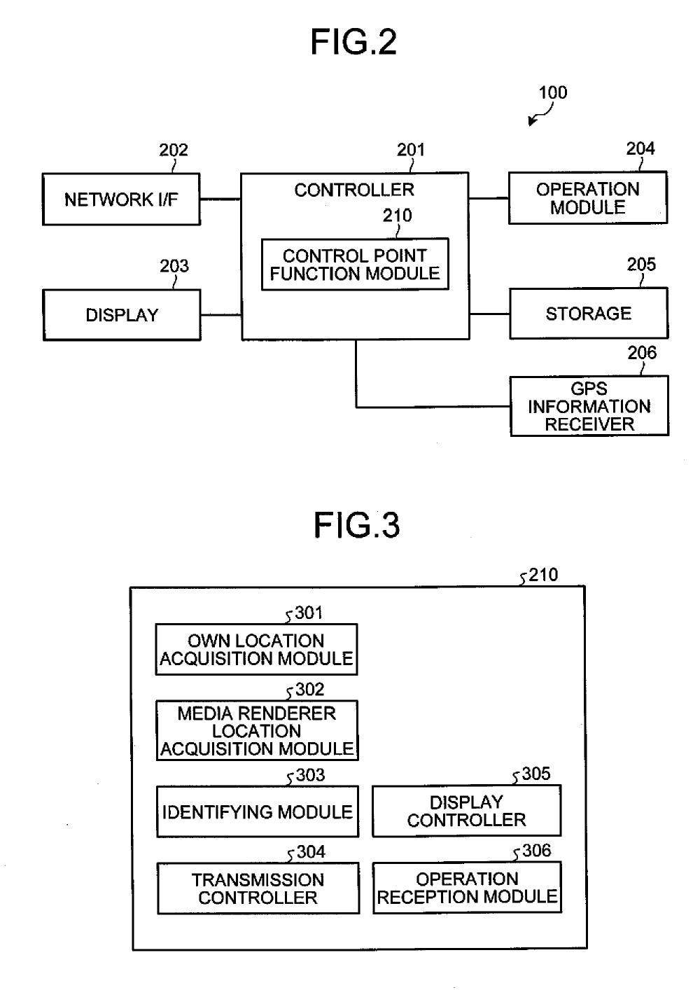

FIG. 2 is a functional block diagram of the control point 100. As illustrated in FIG. 2, the control point 100 comprises a controller 201, a network interface (I/F) 202, a display 203, an operation module 204, a storage 205, and a global positioning system (GPS) information receiver 206.

The control point 100 executes an installed controller program to realize a control point function module 210 operating various devices. A user can reproduce content, for example, by using the control point 100 so as to operate the various devices illustrated in FIG. 1.

The controller 201 comprises a micro controller, a central processing unit (CPU), a random access memory (RAM), and a read only memory (ROM), and centrally controls the operation of the control point 100. For example, the CPU loads various programs stored in the ROM to a working area of the RAM, sequentially executes the programs, and outputs control signals to each module inside the control point 100 to control operation of each module.

The network I/F 202 functions as an interface for communications through the network under the control of the controller 201. Specifically, the network I/F 202 communicates, in accordance with the UPnP AV standard, with the devices, such as the television device 150, the first media renderer 161, and the first media server 162, connected to the control point 100 through the network.

The display 203 is a liquid crystal display (LCD), for example, and displays an operation screen, an error display screen, and the like under the control of the controller 201. The control point 100 notifies a user of a processing result with the screen displayed by the display 203. The notification to a user may be done with voices output from a speaker (not illustrated), for example, under the control of the controller 201.

The operation module 204 may be operation keys or a touch panel for receiving operation instructions from a user. The received operation instructions are notified to the controller 201. The storage 205 may be the RAM or a rewritable non volatile memory.

The GPS information receiver 206 receives GPS information from GPS satellites to obtain location information representing the location of the control point 100 by the latitude and longitude.

The controller 201 executes the controller program stored in the ROM to realize the control point function module 210. The control point function module 210 controls communications over the network I/F 202 in accordance with the UPnP AV standard through the network. Specifically, the control point function module 210 controls communications relating to searching devices connected to the network, acquiring desired information such as content information from the searched device, and desired operation on the searched device. The information acquired from each device is stored in the storage 205 under the control of the control point function module 210.

In the embodiment, a smartphone, which a user can carry anywhere, is used as the control point 100. Any electronic device that a user can carry anywhere may be used as the control point 100 besides the smartphone.

A software structure realized in the control point function module 210 of the control point 100 will be described. FIG. 3 schematically illustrates the software structure realized in the control point function module 210 of the control point 100.

As illustrated in FIG. 3, the control point function module 210 comprises an own location acquisition module 301, a media renderer location acquisition module 302, an identifying module 303, a transmission controller 304, a display controller 305, and an operation reception module 306.

The own location acquisition module 301 acquires location information representing the location of the control point 100. In the embodiment, the location information of the control point 100 is acquired through the GPS information receiver 206. The location of the control point 100 is measured by utilizing radio waves transmitted by the GPS satellites.

The media renderer location acquisition module 302 acquires location information representing the location of each media renderer. The media renderer location acquisition module 302 according to the embodiment acquires the location information from the media renderer connected to the control point 100 through the network I/F 202.

The identifying module 303 calculates the distance between the control point 100 and each media renderer based on the location information of each media renderer and the location information of the control point 100. The identifying module 303 identifies the media renderer serving as the reproduction destination of content based on the distance to each media renderer. In the embodiment, the media renderer located at the shortest distance from the control point 100 is identified as the reproduction destination of content.

The display controller 305 allows the display 203 to display the media renderers capable of reproducing content. In this regard, all of the devices capable of reproducing content (devices having the media renderer function) including the device located at the shortest distance from the control point 100 may be displayed, or only the device located at the shortest distance from the control point 100 may be displayed. When all of the devices are displayed, a decoration that a user can recognize, for example, may be added to the display of the device located at the shortest distance from the control point 100.

The operation reception module 306 receives a selection of the media renderer from the media renderers displayed by the display controller 305 through the operation module 204.

The transmission controller 304 transmits a request to display data to the media renderer whose selection is received by the operation reception module 306. In the embodiment, the media renderer located at the shortest distance from the control point 100 is identified, and thereafter a reproduction request is transmitted to the media renderer whose selection is received. The procedure is not limited to this case. For example, once the identifying module 303 identifies the media renderer, a request to display content may be transmitted immediately to the identified media renderer.

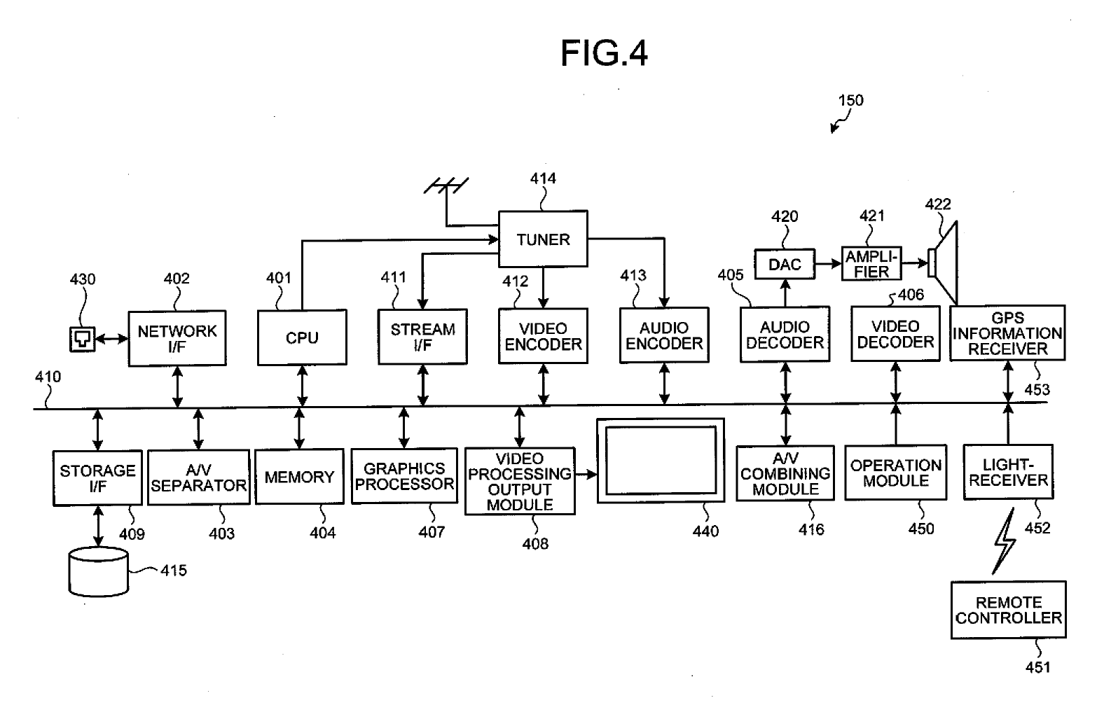

The television device 150 will be described. FIG. 4 is a block diagram illustrating a hardware structure of the television device 150. As illustrated in FIG. 4, the television device 150 comprises a CPU 401, a network interface (I/F) 402, an audio-video (A/V) separator 403, a memory 404, an audio decoder 405, a video decoder 406, a graphics processor 407, a video processing output module 408, a storage interface (I/F) 409, a bus 410, a stream interface (I/F) 411, a video encoder 412, an audio encoder 413, a tuner 414, a hard disk drive (HDD) 415, an audio-video (A/V) combining module 416, a digital-to-analog converter (DAC) 420, an amplifier 421, a speaker 422, a terminal 430, a display panel 440, an operation module 450, a remote controller 451, and a light-receiver 452.

An analog video signal received by the tuner 414 is encoded by the video encoder 412. An analog audio signal received by the tuner 414 is encoded by the audio encoder 413. The encoded video signal and audio signal are combined by the A/V combining module 416 to form a stream. On the other hand, a digital video signal received by the tuner 414 is input to the stream I/F 411 as a stream of a moving picture experts group 2 (MPEG2) -transport stream (TS) format, for example. The stream is recorded in the HDD 415 through the storage I/F 409.

The terminal 430 is the Ethernet (registered trademark) terminal to couple with a network, for example. Information received from another device having a content transmission function connected to the network is transmitted through the terminal 430 and the network I/F 402 to be received by the television device 150.

The stream recorded in the HDD 415, and data of content that is received from another device having the content transmission function through the terminal 430 and the network I/F 402 and temporarily stored in the memory 404, are separated into video data and audio data by the A/V separator 403 under the control of the CPU 401. The video data after separation is decoded by the video decoder 406. The decoded video data is output from the video processing output module 408 as a video signal, and displayed on the display panel 440. The audio data after separation of the A/V separator 403 is decoded by the audio decoder 405, processed by the DAC 420 and the amplifier 421, and output from the speaker 422.

The CPU 401 executes various programs stored in a storage medium such as the ROM (not illustrated) and the HDD 415 to overall control the operation of the television device 150. Specifically, the CPU 401 produces a graphical user interface (GUI) display screen, for example, in cooperation with the graphics processor 407, stores the GUI display screen in the memory 404 such as the RAM, and reads and displays the screen on the display panel 440 as needed. When receiving operation performed to the television device 150 by using the remote controller 451, for example, through the operation module 450 and the light-receiver 452, the CPU 401 switches broadcast signals (channels) received by the tuner 414 in response to the operation, or detects input on the GUI display screen.

A GPS information receiver 453 receives the GPS information from the GPS satellites to obtain the location information representing the location of the television device 150 by the latitude and longitude.

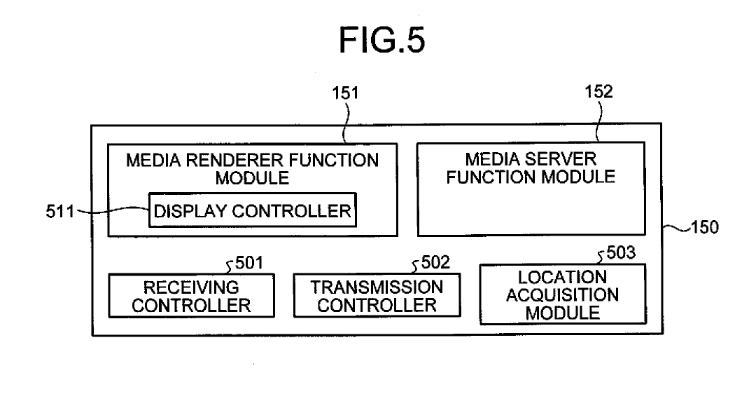

The functional structure of the television device 150 will be described. FIG. 5 schematically illustrates a software structure realized in the television device 150 by executing a video processing program to realize the media renderer function and the media server function.

As illustrated in FIG. 5, the television device 150 executes the controller program to realize the media renderer function module 151, the media server function module 152, a receiving controller 501, a transmission controller 502, and a location acquisition module 503.

The receiving controller 501 controls the network I/F 402 to receive information from electronic devices connected to the television device 150 through the network.

The transmission controller 502 controls the network I/F 402 to transmit information to electronic devices connected to the television device 150 through the network.

The location acquisition module 503 uses the GPS information receiver 453 to acquire the location information representing the location of the television device 150.

When the receiving controller 501 receives a location information request from the control point 100, the transmission controller 502 transmits the location information representing the location of the television device 150 to the control point 100.

Subsequently, the receiving controller 501 receives a request to register content. The registration request comprises an Internet protocol (IP) address identifying the media server that stores content therein. The transmission controller 502 transmits a request to acquire content to the media server identified by the IP address. Then, the receiving controller 501 receives the content in response to the acquisition request from the identified media server.

The media renderer function module 151 comprises a display controller 511. When receiving a request to reproduce content from an external electronic device, the media renderer function module 151 controls reproduction of content stored in the device having the media server function.

The display controller 511 controls reproduction (displaying) of the content received by the receiving controller 501 from the media server on the display panel 440.

The media server function module 152 uses the transmission controller 502 to transmit content stored in the HDD 415 to the media renderer.

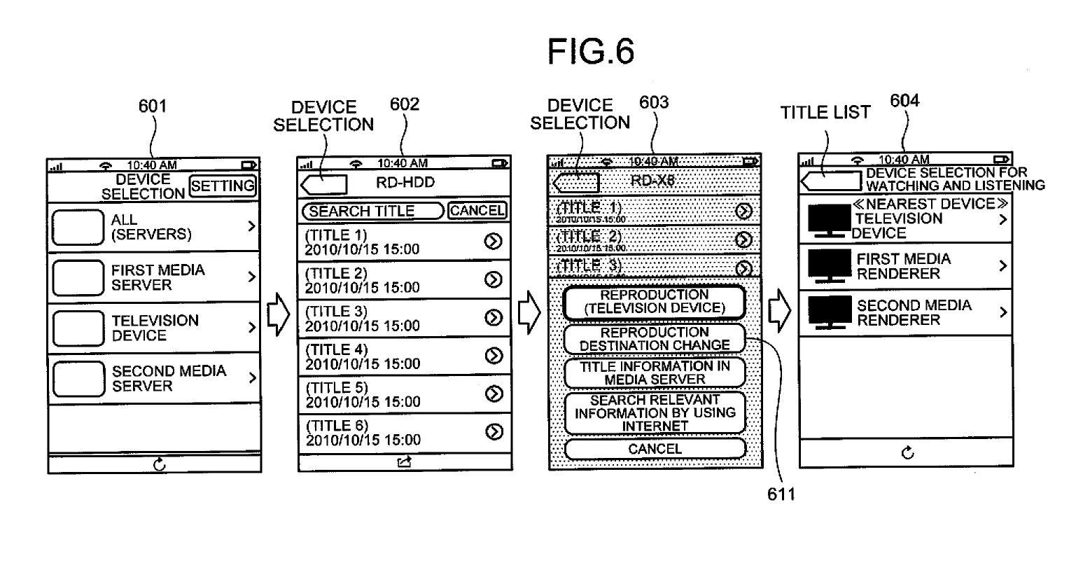

Screen transition in the control point 100 until content is reproduced by the media renderer will be described. FIG. 6 schematically illustrates an example of the screen transition in the control point 100.

As illustrated in FIG. 6, the display controller 305 of the control point 100 displays a screen 601 for selecting media servers storing content to be reproduced. When the operation reception module 306 receives a selection of the media server, the receiving controller 501 receives title information representing content capable of being reproduced from the selected media server.

With the receiving of the title information by the receiving controller 501, the display controller 305 displays a screen 602 displaying a list of title names, for example, included in the title information. The operation reception module 306 receives a selection of a title representing content to be reproduced from the list of the screen 602.

Then, the display controller 305 displays a screen 603 for selecting operation on the selected content whose selection is received by the operation reception module 306. As illustrated in the screen 603, desired operation can be selected from reproduction, a reproduction destination change 611, displaying title information in the media server, and searching relevant information by using the Internet.

When the operation reception module 306 receives the selection of the reproduction destination change 611, the own location acquisition module 301 acquires the location information of the control point 100, the media renderer location acquisition module 302 acquires the location information of each media renderer, and the identifying module 303 identifies the media renderer that is nearest to the control point 100 based on the acquired location information.

Subsequently, the display controller 305 displays a screen 604 displaying a list of the media renderers capable of reproducing content. In the screen, the display controller 305 adds a decoration of “nearest device” on the display of the media renderer that is nearest to the control point 100 so that a user can recognizes the media renderer. The way of displaying to recognize that the media renderer is the nearest device is not limited to the decoration illustrated in the screen 604. Any displaying manner may be used to recognize the name of the media renderer. For example, a special decoration may be added, or the font size of the name may be changed.

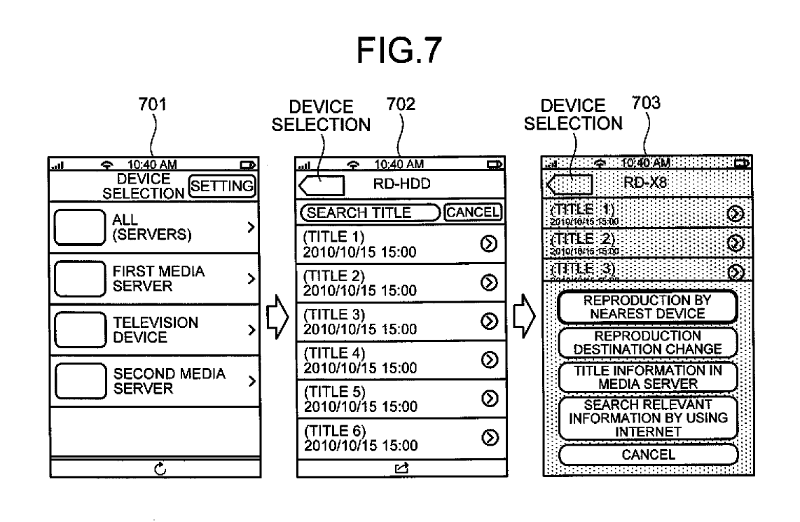

The screen transition for selecting the media renderer that is nearest to the control point 100 is not limited to that of FIG. 6. FIG. 7 schematically illustrates another example of the screen transition in the control point 100. Screens 701 and 702 for receiving a selection of a title are the same as the screens 601 and 602 in the screen transition of FIG. 6.

When the operation reception module 306 receives a selection of a title representing content to be reproduced from the screen 702, the own location acquisition module 301 acquires the location information of the control point 100, the media renderer location acquisition module 302 acquires the location information of each media renderer, and the identifying module 303 identifies the media renderer that is nearest to the control point 100 based on the acquired location information.

Then, the display controller 305 displays a screen 703 for selecting operation on the content whose selection is received by the operation reception module 306. In the screen 703, “reproduction by the nearest device” is displayed as selectable operation. When this operation is selected, the media renderer identified by the identifying module 303 starts reproduction of the content.

In this way, any displaying manner can be used to display the media renderer that is nearest to the control point 100 as long as it allows a user to recognize the media renderer.

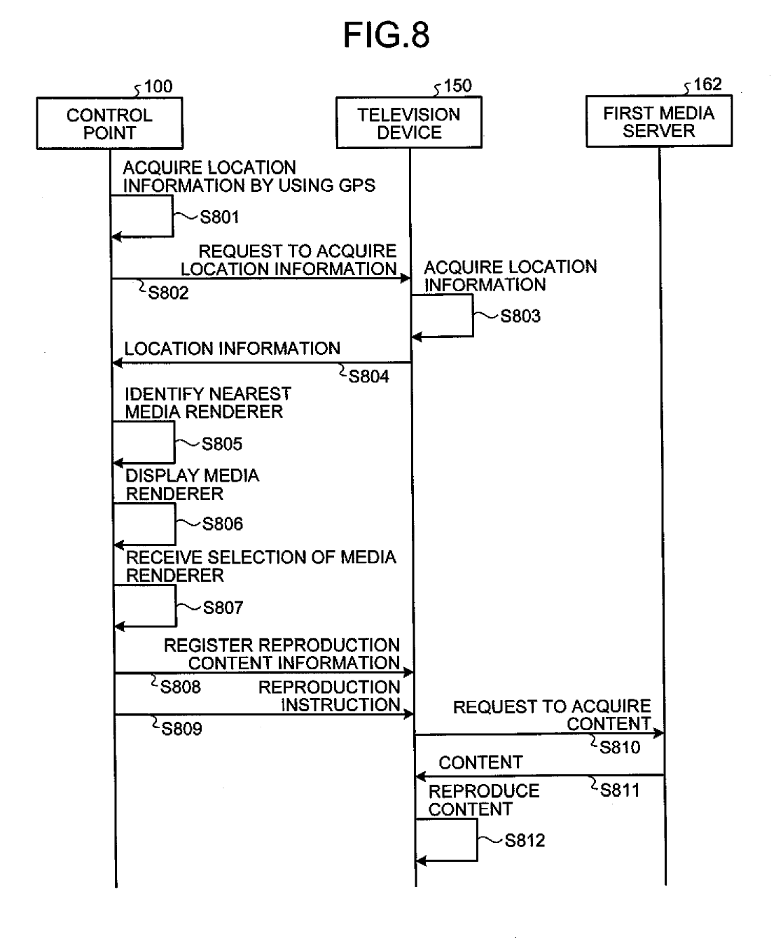

Processing to reproduce content in the network system according to the embodiment will be described. FIG. 8 is a sequence diagram illustrating a procedure of the processing in the network system according to the embodiment. Prior to the sequence illustrated in FIG. 8, content to be reproduced is selected, and the reproduction destination change is selected in the screen 603 of FIG. 6.

In the control point 100, the own location acquisition module 301 allows the GPS information receiver 206 to measure the location of the control point 100 by using the GPS, and acquires the location information (S801).

Then, the transmission controller 304 of the control point 100 transmits a request to acquire location information to the media renderers (including the television device 150) in the network system (S802).

Upon receiving the request, for example, the location acquisition module 503 of the television device 150 measures the own location to acquire the location information. The media renders in the network system acquire the location information in the same manner as the television device 150 (S803). Subsequently, for example, the transmission controller 502 of the television device 150 transmits the acquired location information to the control point 100. The media renderers in the network system transmit the acquired location information to the control point 100 in the same manner as the television device 150 (S804).

After the location information of each media renderer is received, the identifying module 303 of the control point 100 identifies the media renderer located at the shortest distance from the control point 100 based on the location information of each media renderer and the location information of the control point 100 (S805). In the sequence, the television device 150 is identified as the media renderer located at the shortest distance from the control point 100.

Subsequently, the display controller 305 of the control point 100 displays a screen displaying a list of the media renderers capable of reproducing content (S806). Meanwhile, the display controller 305 displays that the television device 150 is identified as the media renderer located at the shortest distance from the control point 100.

The operation reception module 306 receives a selection of the media renderer that reproduces the content (S807). In the sequence, the television device 150 located at the shortest distance from the control point 100 is selected.

The transmission controller 304 of the control point 100 transmits content information representing content to be reproduced to the television device 150 whose selection is received, and requests the television device 150 to register the content information (S808). The content information comprises the IP address representing the media server storing the content.

The transmission controller 304 transmits an instruction to reproduce the content based on the registered content information to the television device 150 (S809).

The transmission controller 502 of the television device 150 transmits a request to acquire the content to the first media server 162 based on the registered content information (S810). Then, the first media server 162 transmits the required content to the television device 150 (S811).

The display controller 305 of the television device 150 reproduces the received content (S812).

Through the processing procedure described as above, a user can identify the media renderer located at the shortest distance from the user and content can be reproduced by the identified media renderer.

In the first embodiment, each device having the media renderer function is described as having the GPS information receiving function. However, each device need not necessarily have the GPS information receiving function. According to a second embodiment, each device does not have the GPS information function. In the second embodiment, the location of each device is measured by using the GPS information receiving function provided in the control point 100.

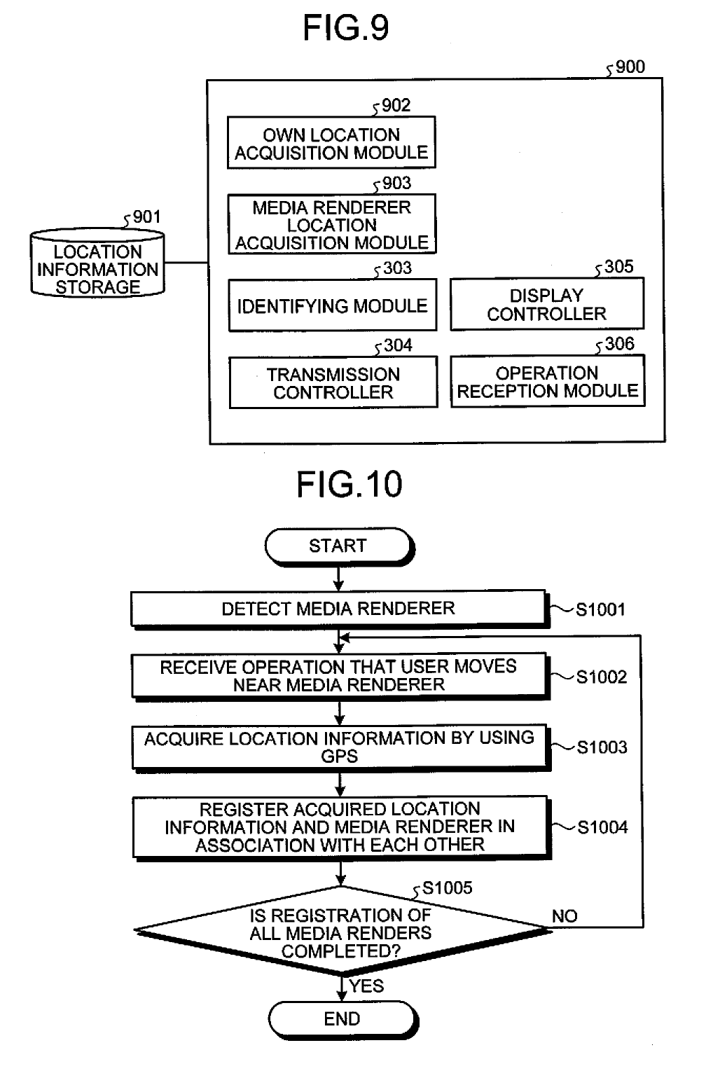

A software structure realizing a control point function module 900 of the control point 100 of the second embodiment will be described with reference to FIG. 9. FIG. 9 schematically illustrates the software structure realizing the control point function module 900 of the control point 100. The control point function module 900 according to the embodiment differs from the control point function module 210 according to the first embodiment in that the own location acquisition module 301 is replaced with an own location acquisition module 902 performing different processing from that of the own location acquisition module 301, and the media renderer location acquisition module 302 is replaced with a media renderer location acquisition module 903 performing different processing from that of the media renderer location acquisition module 302. In addition, a location information storage 901 is provided in the storage 205. In the following description, the same elements as the first embodiment are labeled with the same numerals, and description thereof is omitted.

The location information storage 901 stores therein information identifying the media renderer (e.g., IP address), and the location information of the media renderer such that they correspond to each other.

The own location acquisition module 902 acquires the location information representing the location of the control point 100. The location is measured by utilizing radio waves transmitted by the GPS satellites. Furthermore, in the embodiment, the own location acquisition module 902 acquires the location of the control point 100 measured by utilizing radio waves transmitted by the GPS satellites as the location information representing the location of the media renderer when a user carrying the control point 100 comes close to the media renderer. The own location acquisition module 902 registers the acquired location information in the location information storage 901 such that the acquired location information corresponds to the information identifying the media renderer (e.g., IP address).

The media renderer location acquisition module 903 reads the location information of each media renderer stored in the location information storage 901 to acquire the location information of each media renderer.

Subsequently, processing is performed in the same manner as the first embodiment. For example, the identifying module 303 identifies the media renderer located at the shortest distance from the control point 100.

Processing to register the location of the media renderer performed by the control point 100 according to the embodiment will be described. FIG. 10 is a flowchart of the processing performed by the control point 100 according to the embodiment.

First, the control point 100 detects the media renderers present in the network system (S1001). Meanwhile, the control point 100 also acquires the model name, and the IP address of each media renderer, for example. The display controller 305 of the control point 100 displays the model names of the detected media renderers, and also displays that the user is coming close to a specific media renderer.

The operation reception module 306 receives the operation that the user comes close to a specific media renderer. When the operation reception module 306 receives the operation, it is recognized that the control point 100 has moved near the media renderer to be registered (S1002).

Then, the own location acquisition module 902 acquires the location information from the GPS information receiver 206 measuring the location by using the GPS (S1003).

The own location acquisition module 902 registers the acquired location information as the location information of the detected media renderer in the location information storage 901 in association with, for example, the IP address of the media renderer (S1004).

Then, it is determined whether the control point 100 completes the registration of all of the detected media renderers (S1005). If it is determined that the registration is not complete (NO at S1005), processing starts again from S1002. If it is determined that the registration is complete (YES at S1005), the processing ends.

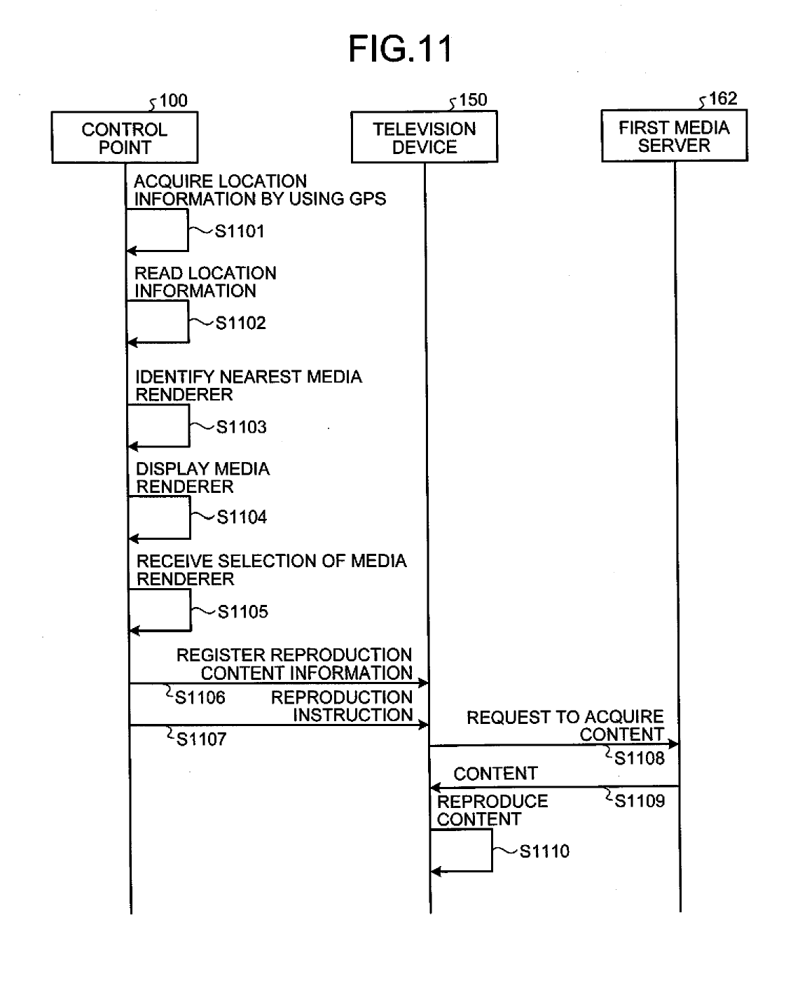

Processing to reproduce content in the network system according to the embodiment will be described. FIG. 11 is a sequence diagram illustrating a procedure of the processing in the network system according to the embodiment. Prior to the sequence illustrated in FIG. 11, content to be reproduced is selected, and the reproduction destination change is selected in the screen 603 of FIG. 6.

In the control point 100, the own location acquisition module 902 allows the GPS information receiver 206 to measure the location of the control point 100 by using the GPS, and acquires the location information (S1101).

Then the media renderer location acquisition module 903 reads the location information of each media renderer from the location information storage 901 together with, for example, the IP address identifying the media renderer (S1102).

After S1102, processing is performed, in the same manner as processing from S805 to S812 in FIG. 8, to reproduce content (S1103 to S1110).

In this way, the control point 100 of the second embodiment allows no GPS information receiver to be provided for each media renderer. As a result, costs of the devices can be reduced and a user can easily use the devices.

In the first and the second embodiments, the GPS is used for measuring the location of the device. The measuring of the location need not necessarily require the GPS. According to a third embodiment, the distance between the control point and each device is calculated without using the GPS.

Each media renderer in the network system according to the third embodiment has a built-in equipment transmitting radio waves. Each media renderer transmits radio waves periodically or in response to a request from the control point. The control point receives the radio waves to calculate the distance between the control point and the media renderer transmitting the radio waves based on intensity of the received radio waves. The media renderer of the embodiment has the same structure as the second embodiment except that the media renderer transmits radio waves. Thus, the description thereof is omitted.

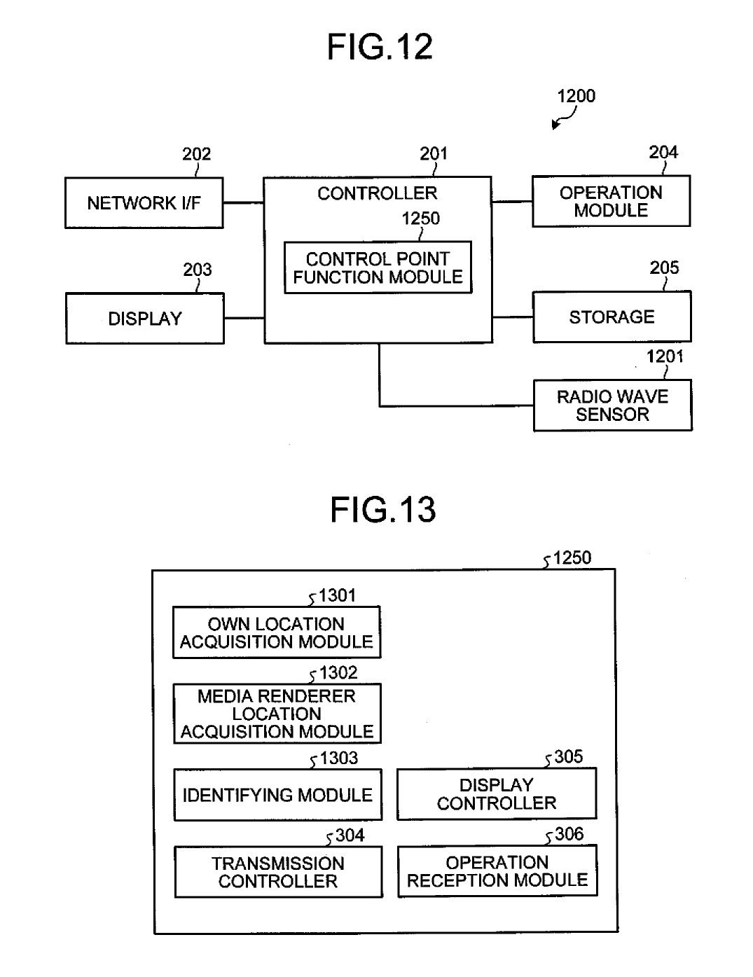

FIG. 12 is a functional block diagram of a control point 1200 according to the third embodiment. The control point 1200 illustrated in FIG. 12 differs from the control point 100 according to the first embodiment in that the GPS information receiver 206 is excluded, a radio wave sensor 1201 is added, and the control point function module 210 is replaced with a control point function module 1250 performing different processing from that of the control point function module 210. In the following description, the same elements as the first embodiment are labeled with the same numerals, and description thereof is omitted.

The radio wave sensor 1201 receives radio waves transmitted by each media renderer to acquire the intensity of radio waves of each media renderer.

A software structure realized in the control point function module 1250 of the control point 1200 will be described. FIG. 13 schematically illustrates the software structure realized in the control point function module 1250 of the control point 1200. The control point function module 1250 according to the embodiment differs from the control point function module 210 according to the first embodiment in that the own location acquisition module 301 is replaced with an own location acquisition module 1301 performing different processing from that of the own location acquisition module 301, the media renderer location acquisition module 302 is replaced with a media renderer location acquisition module 1302 performing different processing from that of the media renderer location acquisition module 302, and the identifying module 303 is replaced with an identifying module 1303 performing different processing from that of the identifying module 303. In the following description, the same elements as the first embodiment are labeled with the same numerals, and description thereof is omitted.

The own location acquisition module 1301 acquires location information representing a relative location between the control point 1200 and each media renderer based on the receiving intensity of the radio waves that are transmitted from each media renderer and received by the radio wave sensor 1201.

The media renderer location acquisition module 1302 acquires location information representing the location of each media renderer with reference to the control point 1200 based on the relative location between the control point 1200 and each media renderer acquired by the own location acquisition module 1301.

The identifying module 1303 calculates the distance between the control point 1200 and each media renderer based on the location information of each media renderer and the location information of the control point 1200, and identifies the media renderer located at the shortest distance from the control point 1200 as a data reproduction destination.

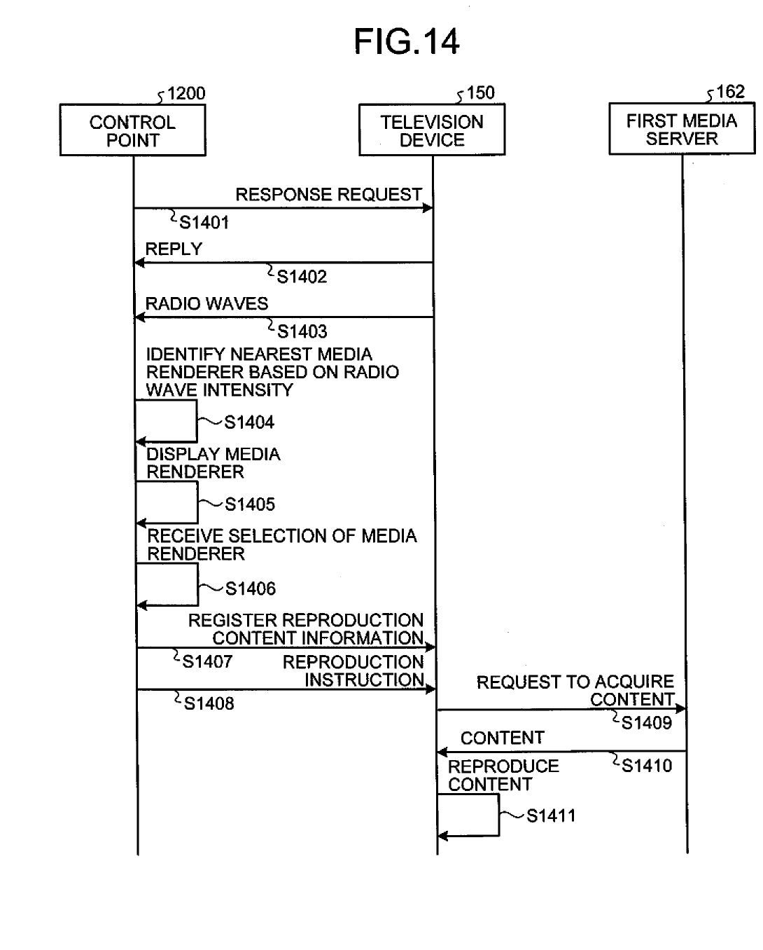

Processing to reproduce content in the network system according to the embodiment will be described. FIG. 14 is a sequence diagram illustrating a procedure of the processing in the network system according to the embodiment. Prior to the sequence illustrated in FIG. 14, content to be reproduced is selected, and the reproduction destination change is selected in the screen 603 of FIG. 6.

In the control point 1200, the transmission controller 304 transmits a response request to each media renderer (including the television device 150) connected to the network system (S1401). Upon receiving the request, for example, the television device 150 transmits a reply in response to the response request to the control point 1200. The other media renders also transmit the replies to the control point 1200 in the same manner as the television device 150 (S1402). With the reply, the control point 1200 can recognize each media renderer in the network system.

Then, the radio wave sensor 1201 receives radio waves transmitted from each media renderer to acquire the intensity of the radio waves of each media renderer (S1403).

Subsequently, the media renderer located at the shortest distance from the control point 1200 is identified based on the radio wave intensity as a result of processing performed by the own location acquisition module 1301, the media renderer location acquisition module 1302, and the identifying module 1303 (S1404).

After S1404, processing is performed in the same manner as processing from S806 to S812 of FIG. 8 to reproduce content (S1405 to S1411).

With the structure of the control point 1200 and the media renders according to the embodiment, the media renderer located at the shortest distance from a user is selected as a reproduction destination based on the relative distances. As a result, an operation burden of the user can be reduced.

In the first to the third embodiments, control is performed to identify the media renderer that first reproduces content. However, the control need not necessarily be performed to identify the media renderer that first reproduces content. The control may be used for processing to switch the media renders reproducing content, as a user moves. according to a fourth embodiment, the media renderers reproducing content are switched as a user moves. Any structures of the control point and the media renders may be employed from the first to the third embodiments. In the forth embodiment, the same structure as the first embodiment is employed. The description thereof is, thus, omitted.

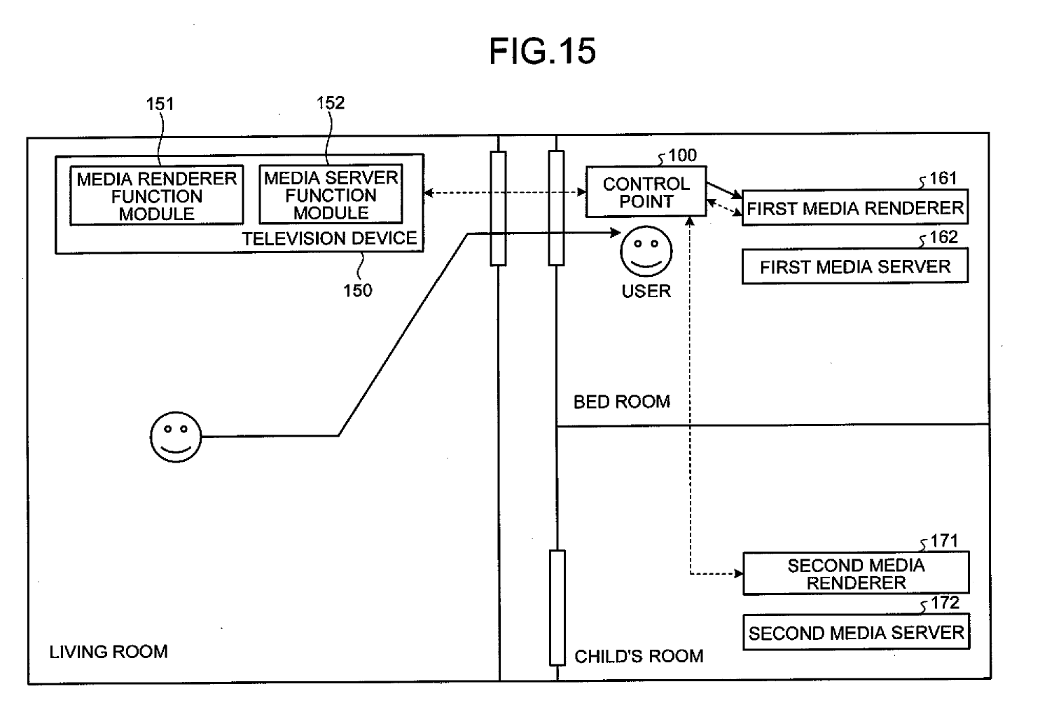

FIG. 15 schematically illustrates a structure of the network system according to the fourth embodiment. In the network system illustrated in FIG. 15, a user moves from a living room, in which the user is involved in the network illustrated in FIG. 1, to a bed room. In this case, the user moves carrying the control point 100. As a result of the movement of the user, the media renderer that is nearest to the control point 100 is changed to the first media renderer 161 from the television device 150. The control point according to the embodiment controls switching of the media renders reproducing content in response to the change.

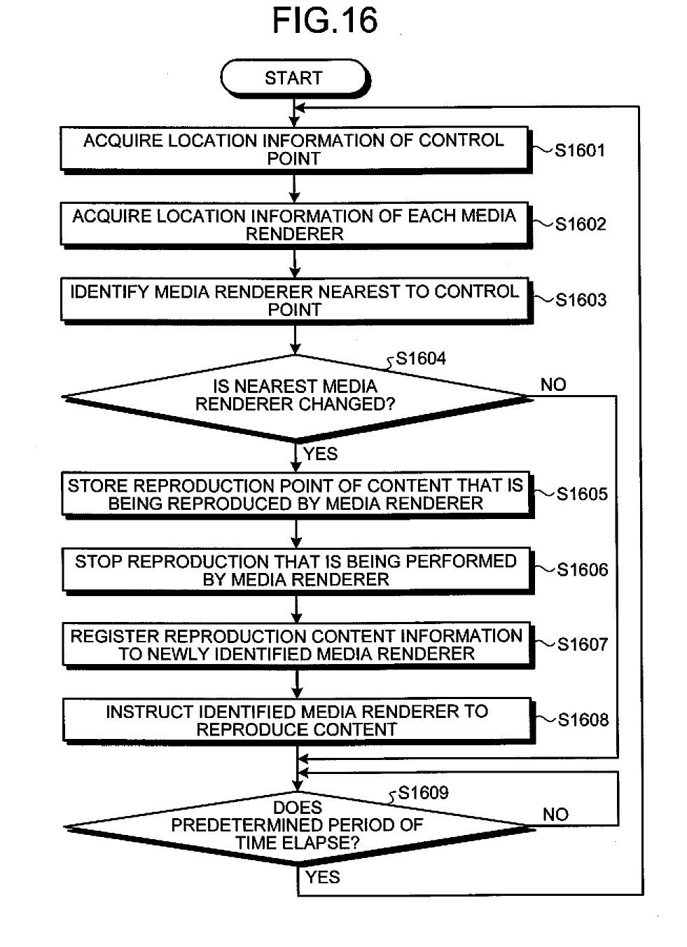

Processing performed by the control point 100 to switch media renderers reproducing content will be described. FIG. 16 is a flowchart of the processing performed by the control point 100 according to the embodiment. Prior to the processing illustrated in FIG. 16, content starts being reproduced.

In the control point 100, the own location acquisition module 301 allows the GPS information receiver 206 to measure the location of the control point 100 by using the GPS, and acquires the location information (S1601).

Then, the media renderer location acquisition module 302 acquires the location information of each media renderer (S1602). The location information received from each media renderer may be stored in the storage 205 when the content starts being reproduced, and may be read from the storage 205, or the media renderer location acquisition module 302 may receive again the location information from each media renderer.

The identifying module 303 identifies the media renderer located nearest to the control point 100 based on the location information of each media renderer and the location information of the control point 100 (S1603).

Subsequently, the identifying module 303 determines whether the media renderer located at the shortest distance from the control point 100 is changed (S1604). If it is determined that the media renderer located at the shortest distance from the control point 100 is not changed (NO at S1604), the procedure proceeds to S1609.

If the identifying module 303 determines that the media renderer located at the shortest distance from the control point 100 is changed (YES at S1604), the control point function module 210 temporarily stores a reproduction point of the content being reproduced by the media renderer in the storage 205 (S1605). Then, the transmission controller 304 transmits a request to stop the reproduction to the media renderer that is reproducing the content (S1606).

Then, the transmission controller 304 transmits content information representing the content to be reproduced to the media renderer newly identified as the media renderer located at the shortest distance from the control point 100, and requests the identified media renderer to register the content information (S1607).

The transmission controller 304 transmits the instruction to reproduce the content based on the registered content information to the media renderer (S1608). The instruction includes a request to reproduce the content from the reproduction point stored at S1605.

The control point function module 210 determines whether a predetermined period of time elapses (S1609). If it is determined that the predetermined period of time dose not elapse (NO at S1609), the procedure waits until the predetermined period of time elapses.

On the other hand, if it is determined that the predetermined period of time has elapsed (YES at S1609), the control point function module 210 starts again processing from S1601.

Through the processing procedure described as above, every predetermined period of time, the media renderer that is nearest to the control point 100 is detected, and the reproduction destination is switched among the media renders based on the detection.

According to the first to the fourth embodiments, the media renderer located at the shortest distance from a user can be identified, and content can be reproduced by the identified media renderer. As a result, an operation burden of the user to reproduce content can be reduced.

The controller program executed on the control point of the above embodiments may be provided as being stored in a computer-readable storage medium, such as a compact disc-read only memory (CD-ROM), a flexible disk (FD), a compact disc recordable (CD-R), and a digital versatile disc (DVD), as a file in an installable or executable format.

The controller program may also be stored in a computer connected via a network such as the Internet so that it can be downloaded therefrom via the network. Further, the controller program may be provided or distributed via a network such as the Internet.

The controller program has a module structure comprising the modules and controllers as described above (the own location acquisition module, the media renderer location acquisition module, the identifying module, the transmission controller, the display controller, and the operation reception module). As real hardware, the CPU (processor) loads the controller program from the ROM into a main memory and executes it. This implements the own location acquisition module, the media renderer location acquisition module, the identifying module, the transmission controller, the display controller, and the operation reception module on the main memory.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processor, comprising:
a first location acquisition module configured to acquire processor location information representing a location of the information processor;
a second location acquisition module configured to acquire display device location information representing a location of a plurality of display devices, each display device capable of displaying data;
an identifying module configured to identify one of the display devices to display the data based on a distance between the information processor and each of the display devices from the display device location information and the processor location information; and
a transmitter configured to transmit a request to display the data to the display device identified by the identifying module.

2. The information processor of claim 1, wherein the identifying module is configured to identify the display device located nearest to the information processor, and to display the data based on the distance between the information processor and each of the display devices from the display device location information and the processor location information.

3. The information processor of claim 2, further comprising:
a display controller configured to display an indication that the display device identified by the identifying module is located nearest to the information processor; and
a reception module configured to receive a selection of the display device displayed by the display controller,
wherein the transmitter is configured to transmit a request to display the data to the display device, the selection of which is received by the reception module.

4. The information processor of claim 1, wherein
the first location acquisition module is configured to acquire the processor location information representing the location of the information processor, the location being measured by radio waves transmitted by artificial satellites, and
the second location acquisition module is configured to acquire the display device location information from each of the display devices.

5. The information processor of claim 1, wherein
the first location acquisition module is configured to acquire the processor location information that represents the location of the information processor, the location being measured by radio waves transmitted by artificial satellites, to acquire the display device location information of each of the display devices, measured by the radio waves transmitted by the artificial satellites, when the information processor comes close to the display device, and to store the display device location information in a storage, and
the second location acquisition module is configured to acquire the display device location information stored in the storage.

6. The information processor of claim 1, wherein
the first location acquisition module is configured to acquire the processor location information representing a relative location between the information processor and each of the display devices based on radio waves transmitted from the display device, and
the second location acquisition module is configured to acquire the display device location information representing the location of each of the display devices based on the relative location between the information processor and the display device, the relative location being represented by the processor location information.

7. A display device, comprising:
a location acquisition module configured to acquire device location information representing a location of the display device;
a transmitter configured to transmit the device location information to an information processor, and to transmit a request for data to a server;
a receiver configured to receive identification information identifying the server from the information processor, and to receive the data in response to the request from the server identified by the identification information; and
a display module configured to display the data.

8. The display device of claim 7, wherein the location acquisition module is configured to acquire the device location information representing the location of the display device measured by radio waves transmitted by artificial satellites.

9. A device control method, comprising:
acquiring processor location information representing a location of the information processor;
acquiring display device location information representing a location of a plurality of display devices capable of displaying data;
identifying one of the display devices to display the data based on a distance between the information processor and each of the display devices from the display device location information and the processor location information; and
transmitting a request to display the data to the display device identified at the identifying.

10. The method of claim 9, further comprising:
identifying the display device located nearest to the information processor; and
displaying the data based on the distance between the information processor and each of the display devices from the display device location information and the processor location information.

11. The method of claim 10, further comprising:
displaying an indication that the display device identified by the identifying module is located nearest to the information processor;
receiving a selection of the display device displayed by the display controller; and
transmitting a request to display the data to the selected display device.

12. The method of claim 9, wherein
acquiring the processor location information comprises measuring the location by radio waves transmitted by artificial satellites, and
acquiring the display device location information comprises acquiring the display device location information from each of the display devices.

13. The method of claim 9, further comprising:
storing, by a first location acquisition module, the display device location information in a storage; and
acquiring, by a second location acquisition module, the display device location information stored in the storage,
wherein acquiring the processor location information comprises measuring the location by radio waves transmitted by artificial satellites, and
wherein acquiring the display device location information of each of the display devices comprises measuring the location by the radio waves transmitted by the artificial satellites when the information processor comes close to the display device.

14. The method of claim 9, further comprising, wherein
the processor location information represents a relative location between the information processor and each of the display devices based on radio waves transmitted from the display device, and
the display device location information represents the location of each of the display devices based on the relative location between the information processor and the display device.
